(19) United States
(12) Patent Application Publication
(10) Pub. No.: US 2024/0037472 A1
(43) Pub. Date: Feb. 1, 2024

(54) ASYNCHRONOUS QUEUE BASED INTERACTIONS BETWEEN SERVICES OF A DOCUMENT MANAGEMENT SYSTEM

(71) Applicant: DocuSign, Inc., San Francisco, CA (US)

(72) Inventor: Andrew Lawrence Ness, Snohomish, WA (US)

(21) Appl. No.: 17/876,876

(22) Filed: Jul. 29, 2022

(51) Int. Cl. G06Q 10/06; G06F 16/93; G06F 9/54

(52) U.S. Cl. CPC G06Q 10/06316; G06F 16/93; G06F 9/546

(57) ABSTRACT

A system, for example, a document management system implements an asynchronous work queue for processing work items. Examples of work items include sending an email with a link to a document, execution of a document by receiving a user signature, collaborative editing of a document, configuring a form based on a document for presenting to a user, and so on. The system stores metadata describing work items in an asynchronous work queue. The asynchronous work queue repeatedly receives work items and stores metadata describing the work items. The system creates a work item container including a set of work items stored in the asynchronous work queue that were received during a particular time interval. The system provides the work item container, for example, to a subscriber for execution of work items in the work item container. The system repeats the process for each subsequent time interval.

### TECHNICAL FIELD

The disclosure generally relates to the field of document management, and specifically to using asynchronous queues for processing work items and handling interactions between services in a document management system.

### BACKGROUND

Systems such as online document management systems receive requests that may process a large number of tasks. For example, a document management system may receive a request to send out several hundred emails. Processing a large number of tasks may take significant amount of time. Accordingly, the request may take a long time to complete, causing the requestor to wait for an uncertain amount of time. Furthermore, a service processing the tasks may invoke several components to process the tasks. If a large number of tasks are processed, the likelihood of a component failing before all the tasks are completed in high. If a component fails during the processing of the request, the request fails to complete successfully. To complete the request, the user has to identify the tasks that completed successfully and the tasks that failed to complete. It is cumbersome for users, for example, system administrators to monitor such requests and ensure that they are eventually executed successfully.

### SUMMARY

A system, for example, a document management system uses an asynchronous work queue for processing work items. The system executes services that process work items, for example, send emails including links to documents, present documents to users to acquire signatures of users, allow collaborative editing of documents, and so on. The system stores metadata describing work items in the asynchronous work queue. The asynchronous work queue repeatedly receives work items and stores metadata describing the work items received. The system creates a work item container including a set of work items stored in the asynchronous work queue that were received during a particular time interval. The system waits for work items during a time interval I1 and may repeatedly receive work items. The system stores the received work items in the asynchronous work queue. At the end of the time interval I1, the system generates a work item container including all work items received during the time interval I1. The system provides the work item container for execution of work items in the work item container. The system may create another work item container using work items received during a time interval 12 that occurs after the time interval I1. The system may continue to repeat the process for each subsequent time interval.

According to an embodiment, if a work item is received during the second time interval, the system locks the work item until all the work items of the first work item container are processed. Locking the work item prevents the work item from being processed. This ensures execution of work items in the order they were received.

The asynchronous work queue may implement a pull model such that publishers add work items to the asynchronous work queue and subscribers pull work items from the asynchronous work queue. The asynchronous work queue may implement a push model such that the system selects a service for executing the work items of a work item container and pushes the work item container to the selected service.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

Figure (FIG. 1 is a high-level block diagram of a system environment for a document management system, in accordance with an example embodiment.

FIG. 2 illustrates interactions of services with the asynchronous work queue, according to an embodiment.

FIG. 3 illustrates a push model used by the asynchronous work queue for processing work items, according to an embodiment.

FIG. 4 is a high-level block diagram of a system architecture of the asynchronous work queue, in accordance with an example embodiment.

FIG. 5 shows partitions used for storing work items of asynchronous work queues, according to an embodiment.

FIG. 6 is a flowchart illustrating a process of assembling work item containers, in accordance with an example embodiment.

FIG. 7 an example timeline illustrating the process of assembling work item containers, in accordance with an example embodiment.

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. A letter after a reference numeral, such as “120A,” indicates that the text refers specifically to the element having that particular reference numeral. A reference numeral in the text without a following letter, such as “120,” refers to any or all of the elements in the figures bearing that reference numeral.

### DETAILED DESCRIPTION

A system, for example, a document management system uses an asynchronous work queue to process work items and to manage interactions between document management services. Examples of work items include sending an email with a link to a document, execution of a document by receiving a user signature, collaborative editing of a document, configuring a form based on a document for presenting to a user, and so on. A document management service can use the asynchronous queues to offload work items to be processed later, schedule future work items, publish data for other document management services to subscribe, and provide ordered delivery of messages. The asynchronous work queue groups work items into work item containers and provides them to services or clients for processing.

### Document Management System Overview

The asynchronous work queue is described in the context of a document management system although the techniques disclosed herein are applicable to other types of systems that process other types of tasks. A document management system enables a party (e.g., individuals, organizations, etc.) to create and send documents to one or more receiving parties for negotiation, collaborative editing, electronic execution (e.g., via electronic signatures), contract fulfilment, archival, analysis, and more. For example, the document management system allows users of the party to create, edit, review, and negotiate document content with other users and other parties of the document management system. An example document management system is further described in U.S. Pat. No. 9,634,875, issued Apr. 25, 2017, and U.S. Pat. No. 10,430,570, issued Oct. 1, 2019, which are hereby incorporated by reference in their entireties.

The system environment described herein can be implemented within the document management system, a document execution system, a digital transaction management platform, or any other system that processes tasks using services. It should be noted that although description may be limited in certain contexts to a particular environment, this is for the purposes of simplicity only, and in practice the principles described herein can apply more broadly to the context of any digital transaction management platform. Examples can include but are not limited to online signature systems, online document creation and management systems, collaborative document and workspace systems, online workflow management systems, multi-party communication and interaction platforms, social networking systems, marketplace and financial transaction management systems, or any suitable digital transaction management platform.

Users may choose to take a set of actions with respect to the generated document. Document actions may include, for example, sending the document to another user for approval, signing the document, initiating a negotiation of the terms of the document, and so on. The document management system allows users to customize a workflow for these document actions such that the document management system automatically performs actions upon request.

Any document action represents a work item that is processed by the document management system. A work item is processed when the task represented by the work item is executed. A work item may be processed by executing instructions of one or more modules of a system such as the document management system. Processing a work item may involve configuring a user interface for presentation to a user and receiving one or more user interactions, for example, getting an electronic signature of a user for execution of a document.

FIG. 1 is a high-level block diagram of a system environment 100 for a document management system 110, in accordance with an example embodiment. The system environment 100 enables users 130A-B to more efficiently generate documents with the document management system 110. As illustrated in FIG. 1, the system environment 100 includes a document management system 110, users 130A, 130B, and corresponding client devices 140A, 140B, each communicatively interconnected via a network 150. In some embodiments, the system environment 100 includes components other than those described herein. For clarity, although FIG. 1 only shows two users 130A, 130B and two client devices 140A, 140B, alternate embodiments of the system environment 100 can have any number of users 130A, 130B and client devices 140A, 140B. For the purposes of concision, the web servers, data centers, and other components associated with an online system environment are not shown in FIG. 1.

The document management system 110 is a computer system (or group of computer systems) for storing and managing documents for the users 130A-B. Using the document management system 110, users 130A-B can collaborate to create, edit, review, and negotiate documents. Examples of documents that may be stored, analyzed, and/or managed by the document management system 110 include contracts, press releases, technical specifications, employment agreements, purchase agreements, services agreements, financial agreements, and so on. The document management system 110 can be a server, server group or cluster (including remote servers), or another suitable computing device or system of devices. In some implementations, the document management system 110 can communicate with client devices 140A-B over the network 150 to receive instructions and send documents (or other information) for viewing on client devices 140A-B. The document management system 110 can assign varying permissions to individual users 130A-B or groups of users controlling which documents each user can interact with and what level of control the user has over the documents they have access to.

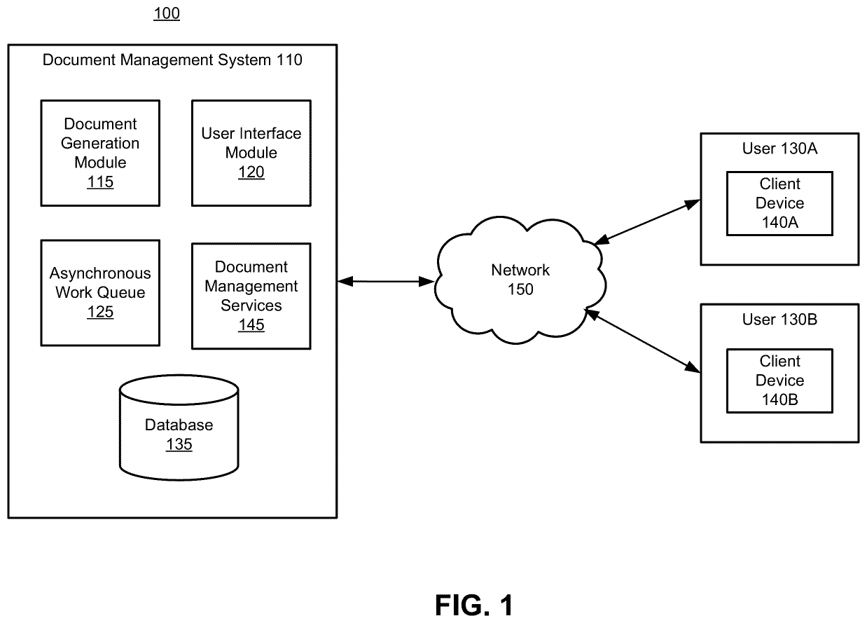

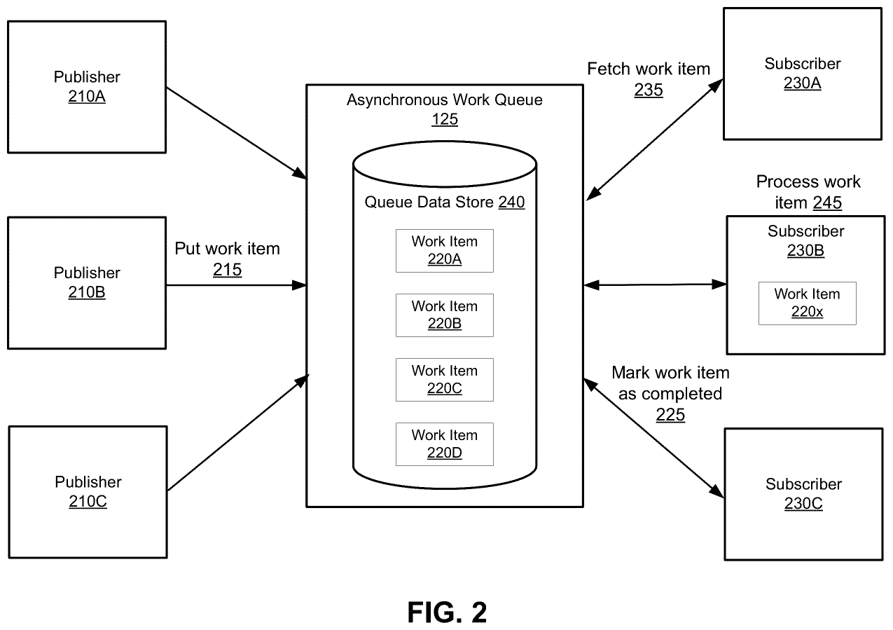

The document management system 110 includes a document generation module 115, a user interface module 120, an asynchronous work queue 125, document management services 145, and a database 135. Computer components such as web servers, network interfaces, security functions, load balancers, failover servers, management and network operations consoles, and the like may not be shown so as to not obscure the details of the system architecture. The document management system 110 may contain more, fewer, or different components than those shown in FIG. 2 and the functionality of the components as described herein may be distributed differently from the description herein.

The database 135 stores information relevant to the document management system 110. Although the embodiments are described in the context of a database 135, the techniques disclosed can be performed using any persistent data store and are not limited to a database. The database 135 can be implemented on a computing system local to the document management system 110, remote or cloud-based, or using any other suitable hardware or software implementation. The data stored by the database 135 may include, but is not limited to, documents for analysis and/or execution, client device identifiers (e.g., of the client devices 140A-B), document clauses, version histories, document templates, and other information about document stored by the document management system 110. In some embodiments, the database 135 stores metadata information associated with documents or clauses, such as documents labeled with training data for machine learning models. The document management system 110 can update information stored in database 135 as new information is received, such as new documents and feedback from users. The document management system 110 can update information stored in the database 135 based on user input received from a user interface, via the user interface module 120. Updates to machine learned models are also stored in the database 135.

The document management services 145 perform predefined operations that may be invoked by a document workflow. These include signing service, identity verification service, form generation service, and so on. According to an embodiment, a document workflow orchestration module invokes APIs for executing any of the document management services 145. A document management service 145 may receive multiple work items to process. For example, a document management service may receive a request to perform one or more operations related to a document workflow to be executed on a set of documents that may include hundreds of documents. Similarly, a document management service may receive a request to send a set of emails, each email providing a link to a document. The set of emails may include hundreds of emails. A document management service may receive a request to configure a user interface to present a document to a user for getting signature of the user on the document. Accordingly, different services may perform different types of operations. An operation performed by a document management service is also referred to herein as a task or a work item. A document management service is also referred to herein as a service.

The asynchronous work queue 125 stores work items that may be performed by document management services 145 of the document management system 110. When a service adds a work item to the asynchronous work queue 125, the document management service 145 passes in a partition key (for example, a globally unique identifier i.e., a GUID) or one is created dynamically by the system. A partition key is also referred to herein as a key. All work items that have the same partition key are located in the same storage volume and thus are returned in order. The asynchronous work queue 125 provides a simple interface with APIs to put work item, take work item, and complete a work item (i.e., remove from the queue). The document management system 110 allows aggregation of work items placed on the queue within a time interval. All work items placed on the queue by services within a time interval of a preconfigured length are accumulated and returned in a single work item container. The order of all work items within the work item container is preserved.

The document generation module 115 facilitates the creation of documents. According to an embodiment, the document generation module 115 automatically generates a form interface with fields for completion. The form interface displays fields that correspond to the user selected candidate document tags and enable input as to specific terms of the document template. The document generation module 115 accesses data values for each of the fields displayed on the form interface. In some embodiments, the document generation module 115 accesses the data values from a relational database and/or other forms of structured data. Once the form interface is completed, the document generation module 115 creates a document preview for the user.

The user interface (UI) module 120 generates user interfaces allowing users (e.g., the users 130A-B) to interact the document management system 110. The UI module 120 displays and receives user input for the embedded tagging interface, the form interface, and the workflow interface in the document management system 110. The UI module 120 also provides a user interface for users to add, delete, or modify the contents of a document template, document preview, or finalized document based on permission definitions. Additionally, in some embodiments, the UI module 120 may provide a user interface that allows users to modify content such as text, images, links to outside sources of information such as databases, and the like.

Users 130A-B of the client devices 140A-B can perform actions relating to documents stored within the document management system 110. Each client device 140A-B is a computing device capable of transmitting and/or receiving data over the network 150. Each client device 140A-B may be, for example, a smartphone with an operating system such as ANDROID® or APPLE® IOS®, a tablet computer, laptop computer, desktop computer, or any other type of network-enabled device from which secure documents may be accessed or otherwise interacted with. In some embodiments, the client devices 140A-B include an application through which the users 130A-B access the document management system 110. The application may be a stand-alone application downloaded by the client devices 140A-B from the document management system 110. Alternatively, the application may be accessed by way of a browser installed on the client devices 140A-B and instantiated from the document management system 110. The client devices 140A-B enables the users 130A-B to communicate with the document management system 110. For example, the client devices 140A-B enables the users 130A-B to access, review, execute, and/or analyze documents within the document management system 110 via a user interface. In some implementations, the users 130A-B can also include AIs, bots, scripts, or other automated processes set up to interact with the document management system 110 in some way. According to some embodiments, the users 130A-B are associated with permissions definitions defining actions users 130A-B can take within the document management system 110, or on documents, templates, permissions associated with other users and/or workflows.

The network 150 transmits data within the system environment 100. The network 150 may be a local area or wide area network using wireless or wired communication systems, such as the Internet. In some embodiments, the network 150 transmits data over a single connection (e.g., a data component of a cellular signal, or Wi-Fi, among others), or over multiple connections. The network 150 may include encryption capabilities to ensure the security of customer data. For example, encryption technologies may include secure sockets layers (SSL), transport layer security (TLS), virtual private networks (VPNs), and Internet Protocol security (IPsec), among others.

### System Architecture of Asynchronous Work Queue

FIG. 2 illustrates interactions of services with the asynchronous work queue, according to an embodiment. As shown in FIG. 2, the document management services use the asynchronous work queue to implement a publish/subscribe model for processing work items. A document management services interact with the asynchronous work queue using APIs (application programming interfaces) supported by the asynchronous work queue.

A document management service may act as a publisher 210. A publisher 210 executes an API 215 to put a work item 220 in the asynchronous work queue 125. Different publishers 210A, 210B, 210C may add different work items 220A, 220B, 220C, 220D in the asynchronous work queue 125. The asynchronous work queue 125 stores the work items in a queue data store 240. A queue data store may be a relational database that uses relational tables for storing attributes of work items.

A document management service may also act as a subscriber 230A. Multiple subscribers 230A, 230B, 230C subscribe to work items 220 stored in the asynchronous work queue 125. A subscriber may execute an API 235 to fetch a work item from the asynchronous work queue 125. A subscriber 230 may process 245 a work item 220x by performing instructions necessary for executing the task specified in the metadata describing the work item 220. Once a subscriber 230 processes 245 a work item, the subscriber 230 may execute an API 225 to mark the work item as completed. The same document management service may be a publisher as well as a subscriber.

The asynchronous work queue 125 maintains order of work items so that they are processed in a first in first out manner. The asynchronous work queue 125 allows services to interact with other services in an asynchronous manner so that one service can store a work item in the asynchronous work queue 125 and another service may process it at any time in future. The ability to communicate asynchronously allows services to manage their load so that a service can postpone processing of a task as necessary.

The asynchronous work queue 125 groups work items into set of work items referred to as work item containers. A work item container is a set of work items that is treated as a unit and provided to a particular subscriber for processing all the work items of the work item container. The asynchronous work queue 125 generates a work item container by assembling a set of work items that arrive within a time interval. If a subscriber requests a work item during the time interval in which the work items of the work item container is being assembled, the asynchronous work queue 125 may return an error code indicating that the work item container is not fully assembled. Alternatively, the asynchronous work queue 125 may return an indication that there are no work items available in spite of there being one or more work items available for processing if the request for work items is received before the end of the time interval. The service may retry again after some time to check if the work item container is ready for processing. In an embodiment, the asynchronous work queue 125 informs the subscribers that are waiting for work items as soon as the work item container is ready for pick up. One of the services that subscribes to work items picks up the work item container.

A service that starts processing a work item container may process a subset of work items of the container and may return the remaining work items to the asynchronous work queue, for example, if the workload of the service exceeds a threshold value. This allows the service to control its workload. The service may pick up another work container at a later stage. Accordingly, the tasks that were offloaded by the service may be picked up by the service again at a later stage. Alternatively, the tasks that were offloaded by a service S1 may be added to a new work container that is picked up for processing by another service S2.

The asynchronous work queue supports both push model and pull model. For example, the subscribers 230 fetch 235 work items using the pull model. Accordingly, if a subscriber invokes a fetch 235 work item API, the asynchronous work queue 125 provides work items to the requestor if available. According to an embodiment, the asynchronous work queue 125 assembles work item containers comprising work items received during a time interval and returns an error or an indication that there are no work items available for processing when a subscriber 230 invokes a fetch 235 API before the time interval is complete. The subscriber 230 in this situation may wait for some time and retry to fetch 235 the work item. The asynchronous work queue 125 returns the work item container if the work item container is ready after the end of the time interval or else the asynchronous work queue 125 continues to return the error message during the time interval.

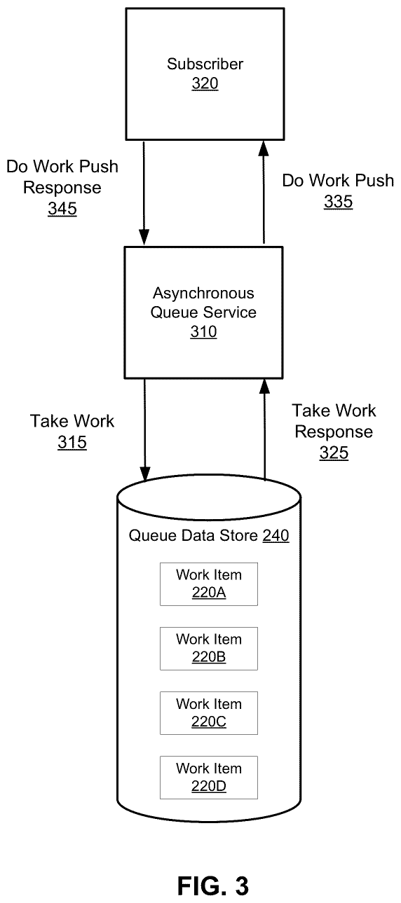

FIG. 3 illustrates a push model used by the asynchronous work queue for processing work items, according to an embodiment. The asynchronous work queue 125 includes an asynchronous queue service 310 module that pushes work items or work item containers to subscribers 320 for processing. For example, the asynchronous queue service 310 executes 315 a TakeWork API to fetch work items from the asynchronous work queue 125. The asynchronous work queue 125 may return one or more work items (e.g., a work item container) as the response 325 TakeWorkResponse to the TakeWork API. The asynchronous queue service 310 selects a subscriber (for example, a client or a service) for processing the work items received from the asynchronous queue service 310. The asynchronous queue service 310 pushes the work items by invoking 335 a DoWork push API. The subscriber 320 responds 345 with a DoWorkResponse, for example, by indicating whether the subscriber successfully processed the work items or not. The work items continue to be stored in the asynchronous work queue 125. However, the status of the work items indicates that they are assigned to the subscriber 320 for processing. If the subscriber 320 processes the received work items successfully as indicated in the DoWorkResponse, the asynchronous queue service 310 may remove the work items from the queue. If the subscriber 320 fails to process the received work items successfully as indicated in the DoWorkResponse, the asynchronous queue service 310 keeps the work items in the asynchronous work queue and changes their status as being available for reassigning to another subscriber.

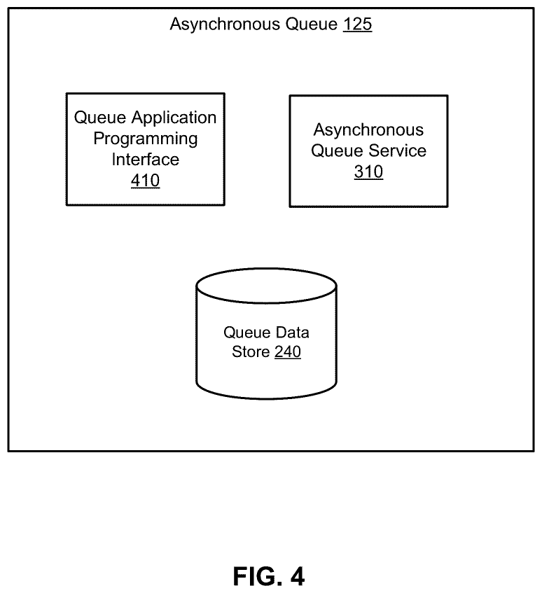

FIG. 4 is a high-level block diagram of a system architecture of the asynchronous work queue, in accordance with an example embodiment. The asynchronous work queue includes the asynchronous queue service 310 (illustrated in FIG. 3 and described in connection with FIG. 3), the queue data store 240 (illustrated in FIG. 2 and described in connection with FIG. 2), and the queue application programming interface 410. Other embodiments may include more, fewer, or other modules than those indicated in FIG. 2 and not all modules of the asynchronous work queue 125 are shown in FIG. 2. Examples of APIs supported by the queue application programming interface 410 include a PutWorkltems API invoked by publishers of work items to inset work items into the asynchronous work queue; a TakeWorkltems API invoked by subscribers to take one or more work items from the asynchronous work queue; and a CompleteWorkltems API called by subscribers to remove a work item from the queue.

According to an embodiment, the document management system includes multiple asynchronous work queues. For example, each work queue may be used to store work items of a particular type. Accordingly, a publisher that publishes a work item of a particular type, invokes the PutWorkltems API on the appropriate asynchronous work queue that is configured for storing the work items of that particular type. Similarly, subscribers that process work items of that particular type invoke the TakeWorkltems API on the appropriate asynchronous work queue configured to store work items of that particular type.

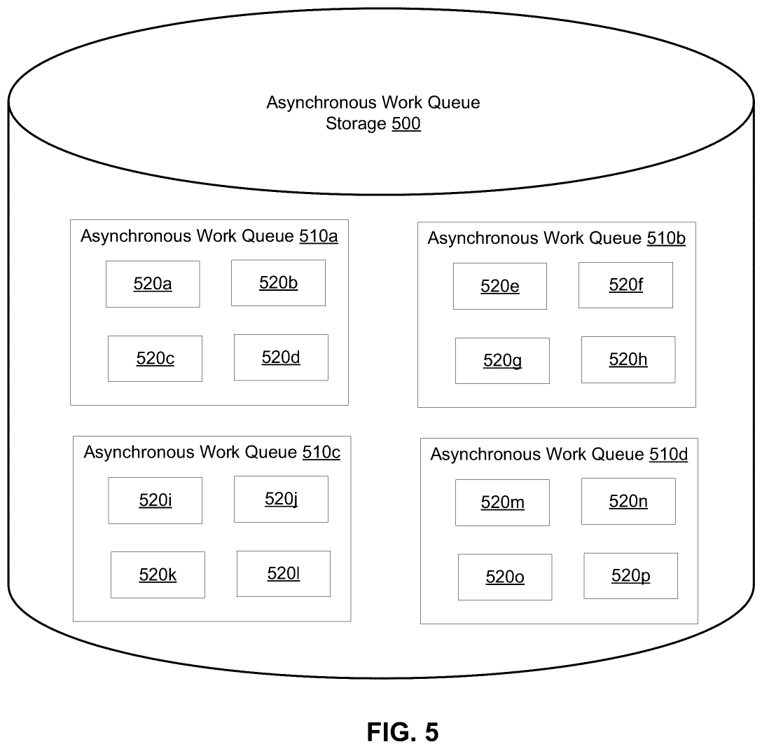

FIG. 5 shows partitions used for storing work items of asynchronous work queues, according to an embodiment. When a work item is added to the asynchronous work queue, a partition key is passed in as an argument. The asynchronous work queue uses the partition key to map the work item to a storage unit, for example, a storage volume. The asynchronous work queue stores all work items having the same partition key in the same storage unit.

According to an embodiment, the system stores work items of the asynchronous work queue in a distributed database system comprising multiple partitions, each partition stored in a separate storage unit, for example, a storage volume. A storage volume may be a physical volume based on a physical storage device such as a hard disk drive, solid state drive, etc. or a logical volume that may group together multiple storage device into a single storage unit.

FIG. 5 shows a distributed database system used as an asynchronous work queue storage 500. The asynchronous work queue storage 500 may comprise multiple storage systems each comprising one or more storage volumes. The asynchronous work queue storage 500 stores multiple asynchronous work queues 510a, 510b, 510c, 510d. Each asynchronous work queue 510 comprises a plurality of partitions 520. For example, asynchronous work queue 510a comprises partitions 520a, 520b, 520c, 520d; asynchronous work queue 510b comprises partitions 520e, 520f, 520g, 520h; asynchronous work queue 510c comprises partitions 520i, 520j, 520k, 520l; and asynchronous work queue 510d comprises partitions 520m, 520n, 520o, 520p. Each partition is associated with a partition key and stores work items that are assigned that partition key. Work items from multiple asynchronous work queues may be stored in the same partition if they are assigned the partition key corresponding to that partition. According to an embodiment, the partition key corresponds to a partition bucket. A partition bucket (PB) is the smallest unit of measure for physically storing a work item. There are N number of PBs inside a partition. The number “N” can be different for different queues. A partition holds PBs from all queues. A single PB contains information from one queue.

According to an embodiment, the asynchronous work queue associates the work item with a timestamp representing the time at which the work item was received. This allows the asynchronous work queue to ensure that all work items stored in the same storage unit, i.e., all work items having the same partition key are processed in the order in which they are received. Work items that are not assigned the same partition key are not guaranteed to be processed in the order in which they are received. For example, assume that a work item W1 is received at time T1 and is assigned a partition key K1 and a work item W2 is received at time T2 and is assigned a partition key K2. Also assume that T1<T2, i.e., work item W1 was received by the asynchronous work queue before work item W2. It is possible that the work item W1 is assigned to a subscriber S1 after the work item W2 is assigned to a subscriber S2 since they two have different partition keys. Accordingly, the work item W1 may be processed by the subscriber S1 after the work item W2 is processed by the subscriber S2. Also assume that a work item W3 is received at time T3 and is assigned a partition key K1 (i.e., same as the partition key of work item W1). If T1<T2, the asynchronous work queue ensures that the work item W1 is assigned to a subscriber before the work item W3. If two work items W1 and W3 have the same partition key and W1 was received before W3, the system guarantees that W1 is PROCESSED before W3. The system waits for W1 to finish processing before assigning W3 to a subscriber to ensure that W1 completes execution before W3.

Accordingly, the asynchronous work queue ensures that the work items having the same partition key are processed in order in which they are received. According to an embodiment, the asynchronous work queue waits for W1 to be completed before allowing W3 to be processed. Accordingly, the asynchronous work queue locks work item W3 until it receives a request to mark the work item W1 as complete. The asynchronous work queue ensures that all work items received before work item W3 are marked complete before the work item W3 is released.

When processing work items in the same work item container, the asynchronous queue enforces an ordering. For example, the asynchronous queue keeps the work items locked and releases them only in order. For example, if W1 and W3 were in same work item container, the asynchronous queue keeps W3 locked until W1 is marked as complete.

### Process of Assembling Work Item Containers

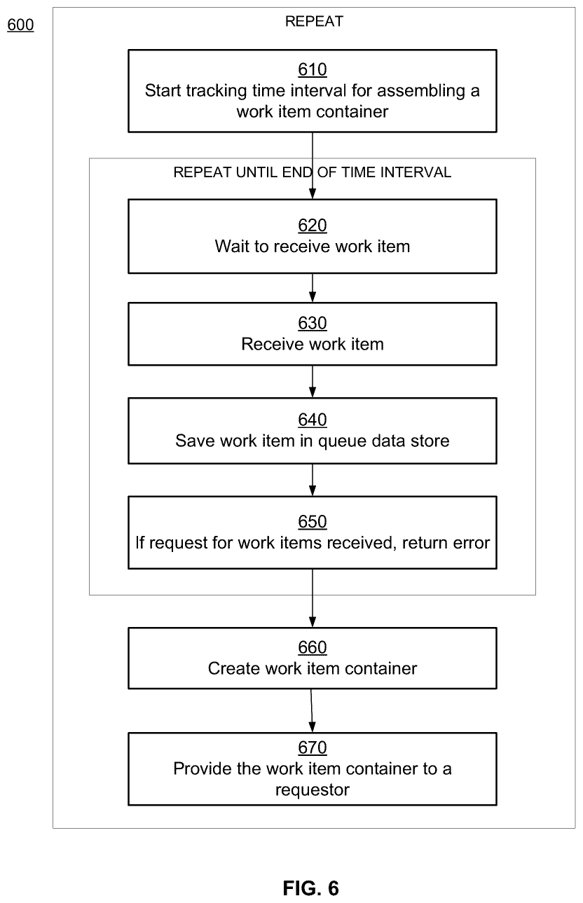

FIG. 6 is a flowchart illustrating a process 600 of assembling work item containers, in accordance with an example embodiment. The steps are indicated as being performed by a system, for example, the document management system. Th steps may be executed by one or more software modules, for example, the software modules shown in FIGS. 1-4.

The steps shown in FIG. 6 including steps 610, 620, 630, 640, 650, 660, 670 are repeated continuously while the system is running, thereby allowing the system to receive and process work items on a continuous basis. The system repeatedly assembles all work items received during a time interval into a work item container on a periodic basis.

The system starts tracking 610 a time interval during which work items are assembled into a work item container. The time interval may start at the end of a previous time interval, when a previous work item container is created based on work items received during the previous time interval. The system performs steps 620, 630, 640, 650 until the current time interval is completed. The system waits 620 to receive a work item. Work items are sent by publishers 210 that may be services. The system receives 630 a work item, for example, a work item sent by a publisher 210. The system saves 640 the work item in the queue data store 240. If the system receives 650 a request for work items, for example, from a subscriber 230, the system either returns an error in response or returns an indication that there are no work items available currently for providing to the requestor, even though the system may have work items that are ready and waiting for processing. According to an embodiment, the system provides a time estimate of the end of the time interval to the requestor so that the requestor may check again for work items based on the time estimate. In another embodiment, the system tracks the requestor and send a notification when the work item container is ready after the end of the time interval. If multiple requests for work items are received, each from a different subscriber, the system may track the subscribers and provide the work item containers on a first come first served basis.

After the time interval ends, the system creates 660 a work item based on all the work items received during the time interval. The system provides 670 the work item container to a requestor, for example, either based on a push model illustrated in FIG. 3 or based on a pull model illustrated in FIG. 2.

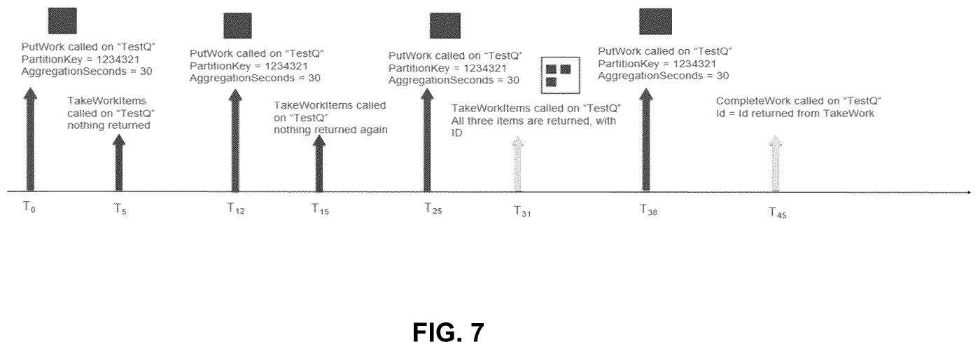

FIG. 7 an example timeline illustrating the process of assembling work item containers, in accordance with an example embodiment. The system starts tracking a time interval I1 at TO. Assume that at TO one work item W1 was added to the asynchronous work queue. At T5, a subscriber calls TakeWorkltem API requesting work items. However, since the end of time interval I1 is not reached yet, the system does not provide any work items in response to the TakeWorkltem request at T5. At T12 another work item W2 is received, for example, as a result of a PutWork API call. At T15 a subscriber calls TakeWorkltem API requesting work items and the system does not provide any work items in response to the TakeWorkltem request at T15. At T25 another work item W3 is received.

At T35 a TakeWorkltem request is received after the time interval is completed. Either in response to the TakeWorkltem request or as soon as the time interval is completed, the system prepares a work item container Cl including the work items W1, W2, and W3 that were received during the time interval. In an embodiment, each work item is associated with a partition key and the system ensures that all work items added to a work item container have the same key. For example, in the example illustrated in FIG. 7, the work items W1, W2, and W3 are assumed to have the same key. Once the work item container Cl is assigned to a subscriber S1 for processing, all the work items of the work item container Cl, for example, work items W1, W2, and W3 are locked and cannot be provided to another subscriber unless the subscriber S1 indicates that the subscriber S1 wants to relinquish control of the work items so that they can be reassigned to another subscriber.

At T38 another work item W4 is received having the same key as W1, W2, and W3. According to an embodiment, the work item W4 is stored in the asynchronous work queue but is locked until the work items W1, W2, W3 that were previously received are processed. This way, the system ensures that all work items having the same key are processed in order.

According to an embodiment, the system ensures the processing order within the work item container to ensure that the work items are processed in the order they are received, for example, work items W2 and W3 are kept locked until work item W1 is processed, then work item W2 is released for processing but work item W3 is kept locked until work item W2 completes processing; and after work item W2 is also processed, W3 is released for processing. For example, as shown in FIG. 7, at T45, the system receives a CompleteWork API invocation that indicates that all work items of the work item container Cl have completed processing. Once the system receives an indication that all work items of the work item container Cl have completed processing, the system deletes the work items of the work item container Cl from the asynchronous work queue and releases the lock of the work item W4 or any work item received after the end of the time interval I1 so that it is available for processing. All work items of a container are also kept locked and released one by one after the previous work items have completed processing, to ensure the order of processing.

The length of time intervals for collecting work items for including in a work item container may be preconfigured, for example, by a system administrator. According to some embodiments, the system dynamically adjusts the lengths of the time intervals based on various factors including the rate at which work items of a particular key are being received by the system, the rate at which the subscribers that are being assigned work item containers of a particular key are processing the work items of the work item container and marking the work items or the work item container as complete. For example, the length of the time interval used for assembling work items having a particular key and added to a work item container has a value that is determined to be inversely proportionate to the rate at which work items having that key are received. Furthermore, the length of the time interval used for assembling work items having a particular key and added to a work item container has a value that is determined to be directly proportionate to the rate at which work items having that key are processed by the subscribers that are assigned the work item containers.

Although the asynchronous work queue is described herein in the context of a document management system, the techniques disclosed herein are applicable to other systems that may not concern document management. For example, the asynchronous work queue may be used in any system that has multiple services that interact with each other to complete work items.

### Additional Configuration Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A computer-implemented method for processing work items in a document management system, the computer-implemented method comprising:
executing, by the document management system, one or more services, each service configured to process work items;
storing, by a document management system, metadata describing work items in an asynchronous work queue, wherein the asynchronous work queue repeatedly receives work items and stores metadata describing the work items;
creating a first work item container comprising a set of work items stored in the asynchronous work queue, the creating comprising:
waiting for work items during a first time interval, the waiting comprising, receiving one or more work items during the first time interval and storing the one or more work items in the asynchronous work queue, and
creating the first work item container comprising the one or more work items received during the time interval;
providing the first work item container for execution of the one or more work items; and
creating a second work item container using work items received during a second time interval that occurs after the first time interval.

2. The computer-implemented method of claim 1, wherein each of the one or more work items of the first work item container is associated with a key, wherein creating the second work item container using work items received during the second time interval comprises:
receiving a new work item during the second time interval, wherein the new work item is associated with the key; and
responsive to determining that the new work item is associated with the key, locking the new work item until each of the one or more work items of the first work item container are processed, wherein locking the work item prevents the work item from being processed.

3. The computer-implemented method of claim 1, further comprising:
selecting a service for executing the work items of the first work item container; and
pushing the work item container to the selected service.

4. The computer-implemented method of claim 1, further comprising:
receiving, from a subscriber, a request for work items during the first time interval;
causing the subscriber to wait until the end of the first time interval;
sending the work item container to the subscriber after the first time interval.

5. The computer-implemented method of claim 4, wherein causing the subscriber to wait comprises:
returning an error in response to the request; and
notifying the subscriber when the work item container is ready for processing.

6. The computer-implemented method of claim 1, further comprising:
receiving information describing status of execution of each work item of the work item container;
identifying one or more work items that failed to complete successfully; and
adding the one or more items to the asynchronous work queue for execution by another service.

7. The computer-implemented method of claim 1, wherein the work item container is provided to a service for execution, further comprising:
responsive to the service executing work items of the work item container determining that the service is overloaded, receiving from the service a subset of work items that were not processed by the service;
storing the received subset of work items in the asynchronous work queue; and
providing work items of the subset of work items for execution as part of a new work item container.

8. The computer-implemented method of claim 7, wherein the service is a first service and the new work item container is provided for execution to the first service after a predetermined delay.

9. The computer-implemented method of claim 7, wherein a work item comprises one or more of:
sending an email with a link to a document;
execution of a document by receiving a user signature; or
collaborative editing of a document.

10. The computer-implemented method of claim 1, wherein the document management system maintains a plurality of asynchronous work queues, wherein an asynchronous work queue is associated with a type of service, and wherein the asynchronous work queue stores work items that can be processed by any service of the type of service.

11. The computer-implemented method of claim 1, wherein each work item is associated with a partition key and work items having a particular partition key are stored in a partition associated with the particular partition key, wherein all work items of the particular partition key are delivered in the order in which the work items were received by the document management system.

12. A non-transitory computer-readable storage medium storing executable instructions that, when executed by one or more computer processors, cause the one or more computer processors to perform steps comprising:
executing, by a document management system, one or more services, each service configured to process work items;
storing, by a document management system, metadata describing work items in an asynchronous work queue, wherein the asynchronous work queue repeatedly receives work items and stores metadata describing the work items;
creating a work item container comprising a set of work items stored in the asynchronous work queue, the creating comprising:
waiting for work items during a first time interval, the waiting comprising, receiving one or more work items during the first time interval and storing the one or more work items in the asynchronous work queue, and
generating the work item container comprising the one or more work items received during the time interval;
providing the work item container for execution of work items in the work item container;
creating a second work item container using work items received during a second time interval that occurs after the first time interval.

13. The non-transitory computer-readable storage medium of claim 12, wherein the executable instructions further cause the one or more computer processors to perform steps comprising:
selecting a service for executing the work items of the work item container; and
pushing the work item container to the selected service.

14. The non-transitory computer-readable storage medium of claim 12, wherein the executable instructions further cause the one or more computer processors to perform steps comprising:
receiving, from a subscriber, a request for work items during the first time interval;
causing the subscriber to wait until the end of the first time interval;
sending the work item container to the subscriber after the first time interval.

15. The non-transitory computer-readable storage medium of claim 12, wherein the executable instructions further cause the one or more computer processors to perform steps comprising:
receiving information describing status of execution of each work item of the work item container;
identifying one or more work items that failed to complete successfully; and
adding the one or more items to the asynchronous work queue for execution by another service.

16. The non-transitory computer-readable storage medium of claim 12, wherein the work item container is provided to a service for execution, wherein the executable instructions further cause the one or more computer processors to perform steps comprising:
responsive to the service executing work items of the work item container determining that the service is overloaded, receiving from the service a subset of work items that were not processed by the service;
storing the received subset of work items in the asynchronous work queue; and
providing work items of the subset of work items for execution as part of a new work item container.

17. A computer system comprising:
one or more computer processors; and
a non-transitory computer-readable storage medium storing executable instructions that, when executed by the one or more computer processors, cause the one or more computer processors to perform steps comprising:
executing, by a document management system, one or more services, each service configured to process work items;
storing, by a document management system, metadata describing work items in an asynchronous work queue, wherein the asynchronous work queue repeatedly receives work items and stores metadata describing the work items;
creating a work item container comprising a set of work items stored in the asynchronous work queue, the creating comprising:
waiting for work items during a first time interval, the waiting comprising, receiving one or more work items during the first time interval and storing the one or more work items in the asynchronous work queue, and
generating the work item container comprising the one or more work items received during the time interval;
providing the work item container for execution of work items in the work item container;
creating a second work item container using work items received during a second time interval that occurs after the first time interval.

18. The computer system of claim 17, wherein the executable instructions further cause the one or more computer processors to perform steps comprising:
receiving, from a subscriber, a request for work items during the first time interval;
causing the subscriber to wait until the end of the first time interval;
sending the work item container to the subscriber after the first time interval.

15. The computer system of claim 17, wherein the executable instructions further cause the one or more computer processors to perform steps comprising:
receiving information describing status of execution of each work item of the work item container;
identifying one or more work items that failed to complete successfully; and
adding the one or more items to the asynchronous work queue for execution by another service.

16. The computer system of claim 17, wherein the work item container is provided to a service for execution, wherein the executable instructions further cause the one or more computer processors to perform steps comprising:
responsive to the service executing work items of the work item container determining that the service is overloaded, receiving from the service a subset of work items that were not processed by the service;
storing the received subset of work items in the asynchronous work queue; and
providing work items of the subset of work items for execution as part of a new work item container.
